(19) United States
(12) Patent Application Publication
(10) Pub. No.: US 2007/0195072 A1
(43) Pub. Date: Aug. 23, 2007

(54) NAVIGATIONAL DEVICE

(75) Inventors: Te-Yao Yeh, Shenzhen (CN); Mo-Liang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/616,891

(22) Filed: Dec. 28, 2006

(30) Foreign Application Priority Data
Feb. 18, 2006 (CN) 200610033846.0

(51) Int. Cl. G09G 5/00

(52) U.S. Cl. 345/184

(57) ABSTRACT

A navigational device is disclosed. The navigational device includes a rotatable wheel. The rotatable wheel is attached in a wheel frame with a first rotatable member. The wheel frame is attached in a chassis with a second rotatable member. The navigational device further comprises a switch. The rotatable wheel pushes the wheel frame to rotate while the rotatable wheel is pressed down. The switch is closed due to a pressure by the wheel frame or the chassis. The rotatable wheel rotates with the wheel frame while being pressing down. The movement is stable without shaking.

### BACKGROUND

1. Technical Field

The present invention relates to a navigational device, and particularly to a navigational device with a rotatable wheel.

2. General Background

Some hand-held devices, such as mobile phones, personal digital assistants, electronic books, etc, adopt a rotatable wheel for selecting and performing functions. Fox example, U.S. Pat. No. 6,862,459 (issued on Mar. 1, 2005) discloses a navigational device. The navigational device includes a rotatable wheel. The rotatable wheel is rotatably supported and depressible by a pair of bearings included in a wheel frame. The wheel frame is fitted in a chassis. Two buttons are fitted on the chassis and near the rotatable wheel. When the rotatable wheel is pressed down, the rotatable wheel moves down vertically. However, the movement is unstable. If a direction of the pressing force deviates away from a vertical direction, the rotatable wheel will shake.

Therefore, what is needed is an navigational device with a rotatable wheel which moves stably.

### SUMMARY

A navigational device is disclosed. The navigational device includes a rotatable wheel. The rotatable wheel is attached in a wheel frame with a first rotatable member. The wheel frame is attached in a chassis with a second rotatable member. The navigational device further comprises a switch. The rotatable wheel pushes the wheel frame to rotate while the rotatable wheel is pressed down. The switch is closed due to a pressure by the wheel frame or the chassis.

Other advantages and novel features will be drawn from the following detailed description with reference to the attached drawing, in which:

### BRIEF DESCRIPTION OF THE DRAWINGS

FIG. 1 is a schematic, solid view of a hand-held device with a navigational device according to a first preferred embodiment of the present invention;

FIG. 2 is a schematic, solid view of the navigational device of FIG. 1;

FIG. 3 is a cross-sectional view of the navigational device of FIG. 2; and

FIG. 4 is a exploded view of the navigational device of FIG. 2.

### DETAILED DESCRIPTION OF THE EMBODIMENT

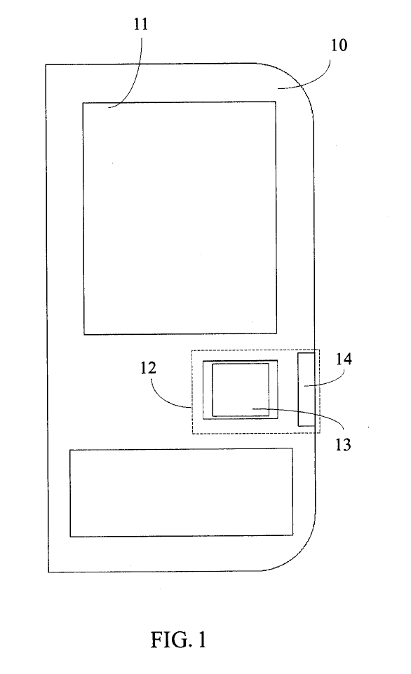

Referring to FIG.1 , a hand-held device 10 is disclosed. The hand-held device 10 includes a display 11 and a navigational device 12. The navigational device 12 includes a rotatable wheel 13 and a button 14.

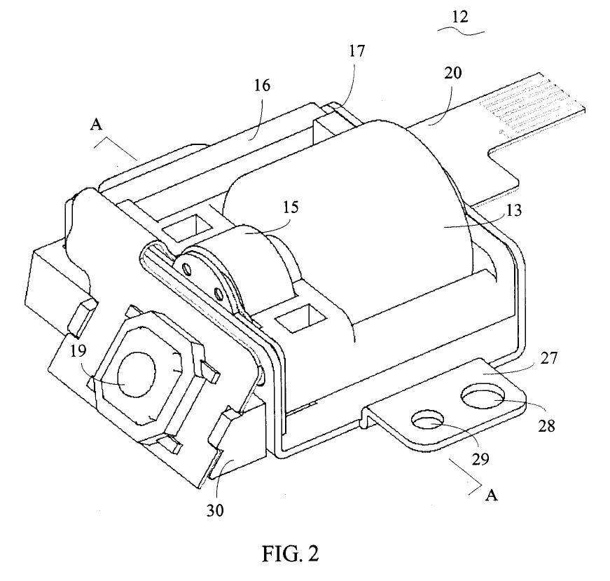

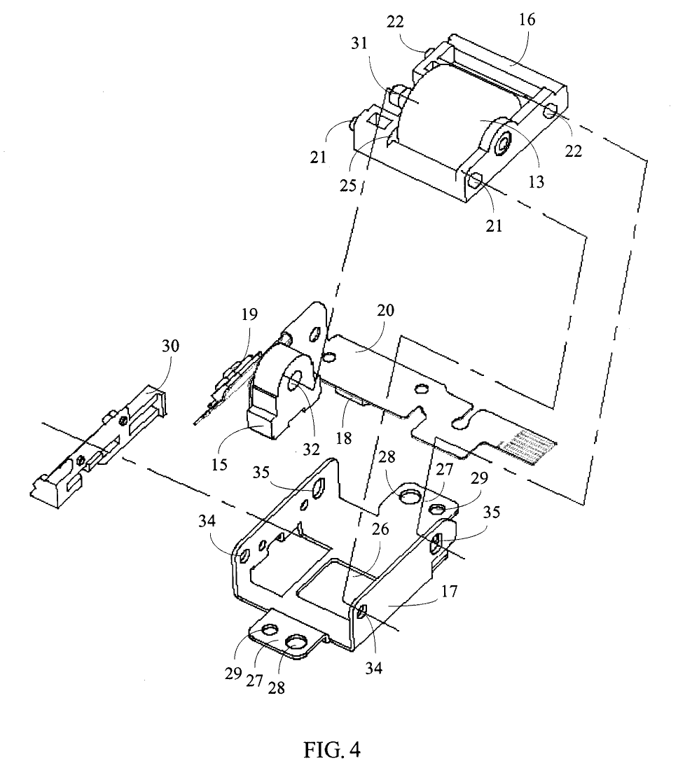

Referring to FIGS. 2, 3, and 4, the navigational device 12 further includes a decoder 15, a wheel frame 16, a chassis 17, a flexible printed circuit board (hereinafter referred to as FPC) 20, and two switchs 18, 19 on the FPC 20. The wheel frame 16 defines a wheel housing 25. The rotatable wheel 13 is rotatably attached in the wheel housing 25 of the wheel frame 16 with a first rotatable member 31. In this embodiment of the invention, the first rotatable member 31 is a shaft that extends through the rotatable wheel 13 along an axis of rotation of the rotatable wheel 13.

The chassis 17 is “U” shaped, and includes a bottom panel and two sidewalls elongated upwardly from two opposite sides of the bottom panel. The wheel frame 16 is pivotably attached to the chassis 17 with a second rotatable member 21. The second rotatable member 21 is a pair of pivots symmetrically protruding outwards at opposite sides of the wheel frame 16 correspondingly. The chassis 17 defines a pair of pivot holes 34 that are configured to align along an axis of rotation of the wheel frame 16. The pivots 21 are inserted to a pair of pivot holes 34 defined on the chassis 17.

The wheel frame 16 is further attached to the chassis 17 with a sliding member 22. The sliding member 22 is a pair of guide shafts symmetrically protruding outwards from opposite sides of the wheel frame 16 correspondingly. The chassis 17 defines a pair of guide holes 35 that are configured to align corresponding to the guide shafts 22. The guide shafts 22 are inserted into the pair of guide holes 35 correspondingly. The guide holes 35 are elongated vertically so that the short shafts 22 are able to move vertically freely within the guide holes 35. When the rotatable wheel 13 is pressed down, the rotatable wheel 13 pushes the wheel frame 13, and the pivots 21 cause the wheel frame 13 to rotate. When the wheel frame 13 rotates, a path of the rotation of the wheel frame 13 is further guided by the guide shafts 22, thus, limiting unstable shakes.

The chassis 17 defines an opening 26 corresponding to a location of the rotatable wheel 13. A portion of the rotatable wheel 13 that is supported in the wheel housing 25 protrudes through the opening 26. Compared to a conventional structure where a wheel housing adopts a holeless solid structure on one side, the rotatable wheel 13 of the present invention can be fitted at a lower position, so that the final height of the navigational device 10 can be reduced.

Two wings 27 extends from opposite sides of the chassis 17. Each of the wings 27 defines holes 28, 29. The navigational device 12 is attached in the hand-held device 10 with the wings 27.

The decoder 15 is attached on the wheel frame 16. The decoder 15 is connected to the rotatable wheel 13 at the shaft 31. The FPC 20 is affixed beneath the wheel frame 16. The FPC 20 is connected with the decoder 15 and an internal circuit of the hand-held device 10 (not shown). When the rotatable wheel 13 rotates, the decoder 15 transmits rotational data of the rotatable wheel 13 to the internal circuit.

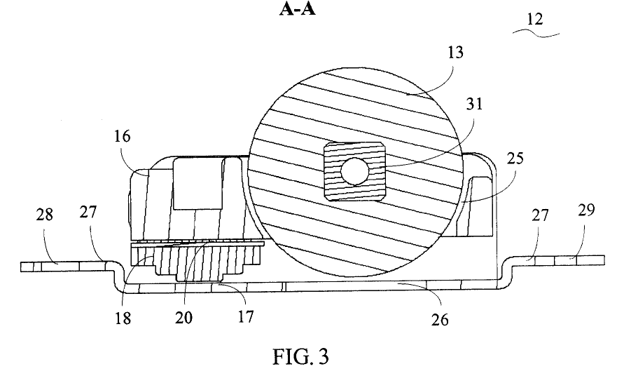

Referring to FIGS. 2 and 3, each of the switch 18, 19 is a retractable switch and includes two apart ends. The switch 18 is attached on the underside of the wheel frame 16. The switch 18 may also be attached on the chassis 17. When the rotatable wheel 13 is pressed down, the wheel frame 16 rotates correspondingly, and two ends of the switch 18 are closed due to a pressure by the chassis 17. The switch 19 is attached on a sidewall of the chassis 17. A triangle-shaped block 30 is fitted between the switch 19 and the chassis 17. When the button 14 is pressed down, two ends of the switch 19 are closed. When the switch 18, 19 is closed, the FPC 20 transmits corresponding electrical signal to the internal circuit.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A navigational device comprising:
a rotatable wheel comprising a first rotatable member;
a wheel frame comprising a second rotatable member;
a chassis;
a switch;
wherein the rotatable wheel is attached in the wheel frame with the first rotatable member, the wheel frame is attached in the chassis with the second rotatable member, the rotatable wheel pushes the wheel frame to rotate while the rotatable wheel is pressed down, and the switch is closed due to a pressure by the wheel frame or the chassis.

2. The navigational device of claim 1, further comprising a decoder for outputting rotational data of the rotatable wheel.

3. The navigational device of claim 1, wherein the wheel frame is further connected with the chassis through a sliding member.

4. The navigational device of claim 3, wherein the sliding member is a pair of short shafts on the wheel frame, and the short shafts engage with a pair of shaft holes on the chassis.

5. The navigational device of claim 4, wherein the second rotatable member is a pair of pivots on the wheel frame, and the short shafts engage with a pair of pivot holes defined in the chassis.

6. The navigational device of claim 1, wherein the switch is attached on an underside of the wheel frame.

7. The navigational device of claim 1, wherein the wheel frame defines a wheel housing for receiving the rotatable wheel.

8. The navigational device of claim 2, further comprising a second switch on a sidewall of the chassis.

9. The navigational device of claim 8, further comprising a flexible printed circuit board for outputting signals generated by the decoder, the switch or the second switch.
